(19) United States
(12) Patent Application Publication
(10) Pub. No.: US 2024/0242172 A1
(43) Pub. Date: Jul. 18, 2024

(54) ROBOTIC RESOURCE ALLOCATION

(71) Applicant: Accenture Global Solutions Limited, Dublin (IE)

(72) Inventors: Michael Nai-An CHEN, San Francisco, CA (US); Sri Sadhan JUJJAVARAPU, San Francisco, CA (US); Sanjoy PAUL, Sugar Land, TX (US)

(21) Appl. No.: 18/154,284

(22) Filed: Jan. 13, 2023

(51) Int. Cl. G06Q 10/087

(52) U.S. Cl. CPC G06Q 10/087

(57) ABSTRACT

In some implementations, a robot controller may receive a list of a set of items based on one or more orders. The robot controller may determine a set of locations relative to a reference location, a set of weights, and a set of volumes associated with the set of items. The robot controller may receive a weight constraint and a size constraint associated with a robotic device. The robot controller may pack a group of items, consisting of a subset of the set of items, based on minimizing a total distance associated with the group based on the set of locations and satisfying the weight constraint and the size constraint based on the set of weights and the set of volumes. The robot controller may transmit instructions to the robotic device to retrieve the subset of the set of items in the group.

### BACKGROUND

In a warehouse, a restaurant, or another setting where goods are sorted and delivered to people, robotic devices may be used to move the goods. In some situations, a robotic device may load multiple items onto the robotic device before delivering the items to a packaging area, a set of tables, or another destination.

### SUMMARY

Some implementations described herein relate to a method. The method may include receiving a list of a set of items based on one or more orders. The method may include determining a set of locations relative to a reference location, a set of weights, and a set of volumes associated with the set of items. The method may include receiving a weight constraint and a size constraint associated with a robotic device. The method may include packing a group of items, consisting of a subset of the set of items, based on minimizing a total distance associated with the group based on the set of locations and satisfying the weight constraint and the size constraint based on the set of weights and the set of volumes. The method may include transmitting instructions to the robotic device to retrieve the subset of the set of items in the group.

Some implementations described herein relate to a device. The device may include one or more memories and one or more processors communicatively coupled to the one or more memories. The one or more processors may be configured to receive a set of items based on one or more orders. The one or more processors may be configured to determine a set of locations relative to a reference location, a set of weights, and a set of volumes associated with the set of items. The one or more processors may be configured to receive a weight constraint and a size constraint associated with a robotic device. The one or more processors may be configured to pack a group of items, consisting of a subset of the set of items, based on minimizing a total distance associated with the group based on the set of locations and satisfying the weight constraint and the size constraint based on the set of weights and the set of volumes. The one or more processors may be configured to transmit instructions to the robotic device to retrieve the subset of the set of items in the group.

Some implementations described herein relate to a non-transitory computer-readable medium that stores a set of instructions for a device. The set of instructions, when executed by one or more processors of the device, may cause the device to receive a set of items based on one or more orders. The set of instructions, when executed by one or more processors of the device, may cause the device to determine a set of locations relative to a reference location, a set of weights, and a set of volumes associated with the set of items. The set of instructions, when executed by one or more processors of the device, may cause the device to receive a weight constraint and a size constraint associated with a robotic device. The set of instructions, when executed by one or more processors of the device, may cause the device to pack a group of items, consisting of a subset of the set of items, based on minimizing a total distance associated with the group based on the set of locations and satisfying the weight constraint and the size constraint based on the set of weights and the set of volumes. The set of instructions, when executed by one or more processors of the device, may cause the device to transmit instructions to the robotic device to retrieve the subset of the set of items in the group.

### BRIEF DESCRIPTION OF THE DRAWINGS

FIGS. 1A-1D are diagrams of an example implementation described herein.

FIGS. 2A-2E are diagrams of example robotic devices described herein.

FIGS. 3A-3F are diagrams of an example implementation described herein.

FIGS. 4A-4B are diagrams of example robotic devices described herein.

FIG. 5 is a diagram of an example environment in which systems and/or methods described herein may be implemented.

FIG. 6 is a diagram of example components of one or more devices of FIG. 5.

FIG. 7 is a flowchart of an example process relating to robotic resource allocation.

### DETAILED DESCRIPTION

The following detailed description of example implementations refers to the accompanying drawings. The same reference numbers in different drawings may identify the same or similar elements.

Robotic devices may be used to move goods (e.g., in a warehouse, a restaurant, or another type of environment). The robotic devices may be configured to move multiple items at once. For example, the robotic devices may load multiple items before delivering the items to a destination (e.g., a packaging station or tables in a restaurant, among other examples). In some situations, the robotic devices may collaborate with humans. For example, the humans may move with the robotic devices and physically place the items into the robotic devices.

The robotic devices consume power, processing resources, and memory resources while functioning. One way to conserve power, processing resources, and memory resources is to assign items to robotic devices based on a minimization of distance that the robotic devices will travel. However, the robotic devices can only carry so much volume and weight. Accordingly, when the robotic devices are overloaded, they may break down, which wastes power, processing resources, and memory resources that are consumed while the robotic devices are not functioning. Alternatively, to avoid breaking down, the robotic devices may perform unscheduled trips to the destination; however, the robotic devices therefore increase travel distance and thus waste power, processing resources, and memory resources.

Additionally, some items may be temperature-sensitive (e.g., hot food to be delivered hot or frozen items to be kept from thawing, among other examples) or otherwise sensitive to a delay in processing. In order to accommodate such items, the robotic devices may perform unscheduled trips to the destination, which increases travel distance for the robotic devices and thus wastes power, processing resources, and memory resources.

Using additional constraints, such as weight, size, and/or delay budget constraints when assigning robotic devices conserves additional power, processing resources, and memory resources. Some implementations described herein enable a controller (e.g., a local controller for one or more robotic devices and/or a remote planner associated with the robotic device(s)) to pack groups of items (e.g., from a list of a set of items) based on minimizing a total distance as well as satisfying a weight constraint and a size constraint. As used herein, “pack” refers to grouping digital representations of items together (e.g., in a same data structure). As a result, the robotic devices are routed more efficiently in order to conserve power, processing resources, and memory resources.

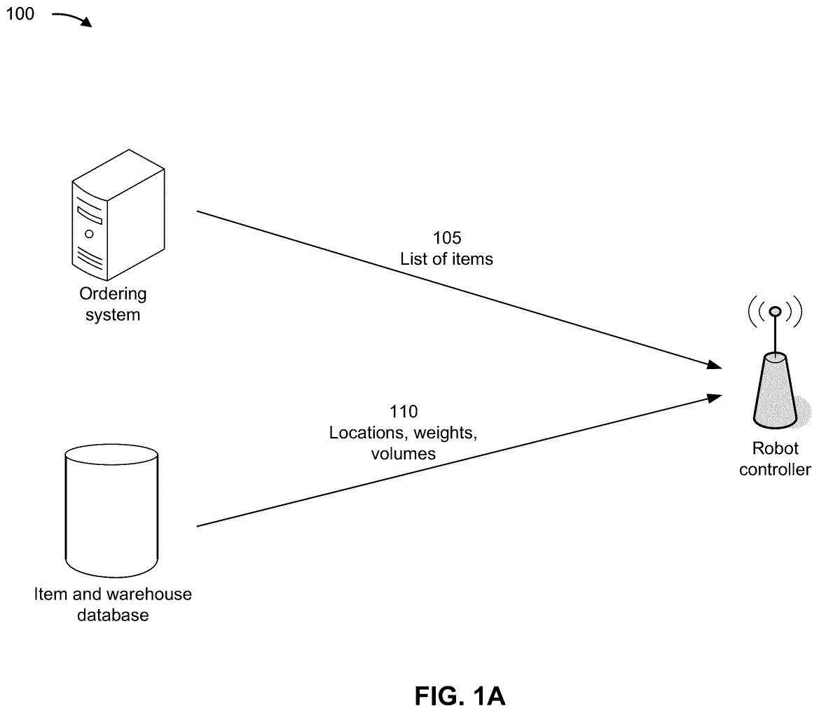

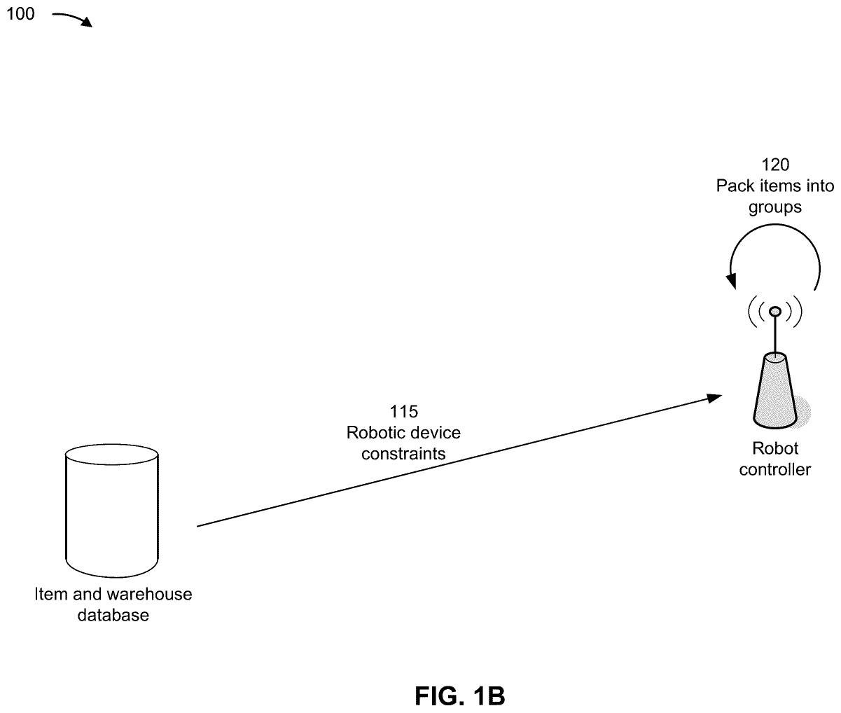

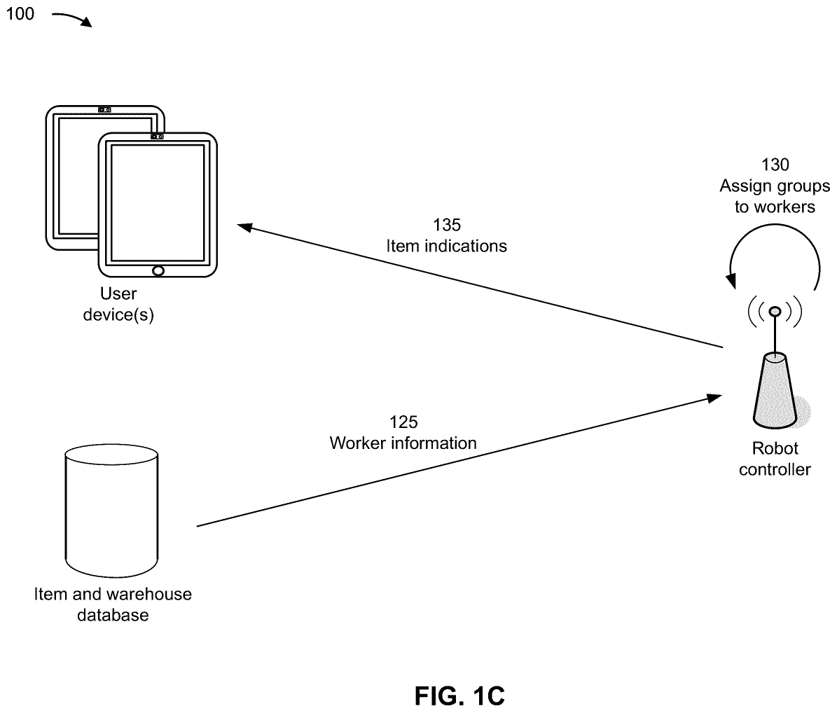

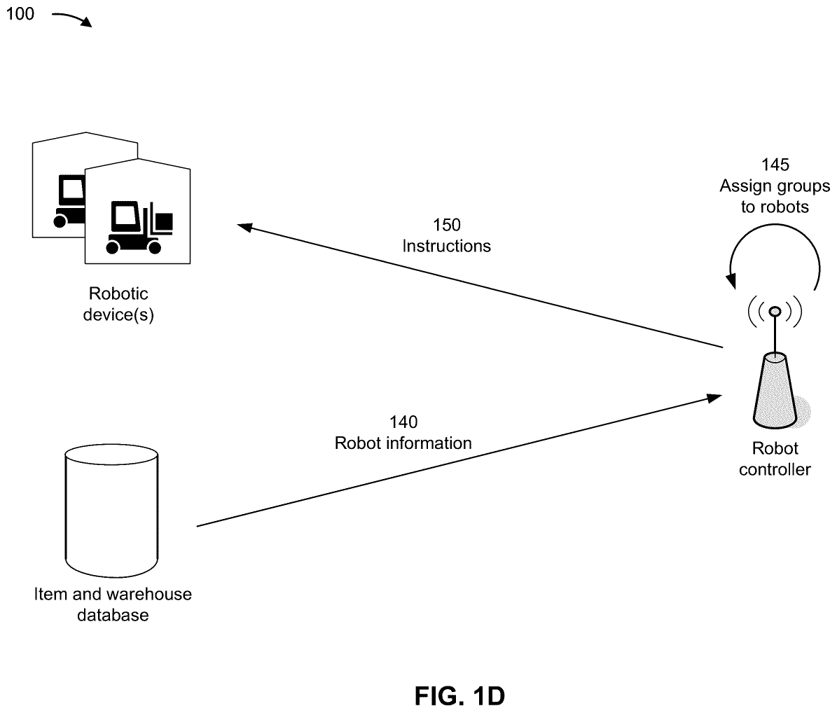

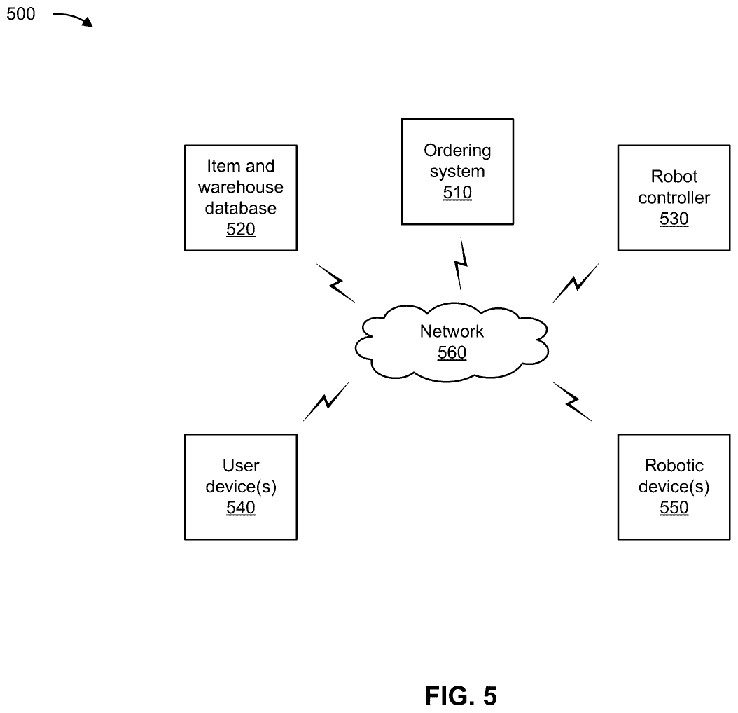

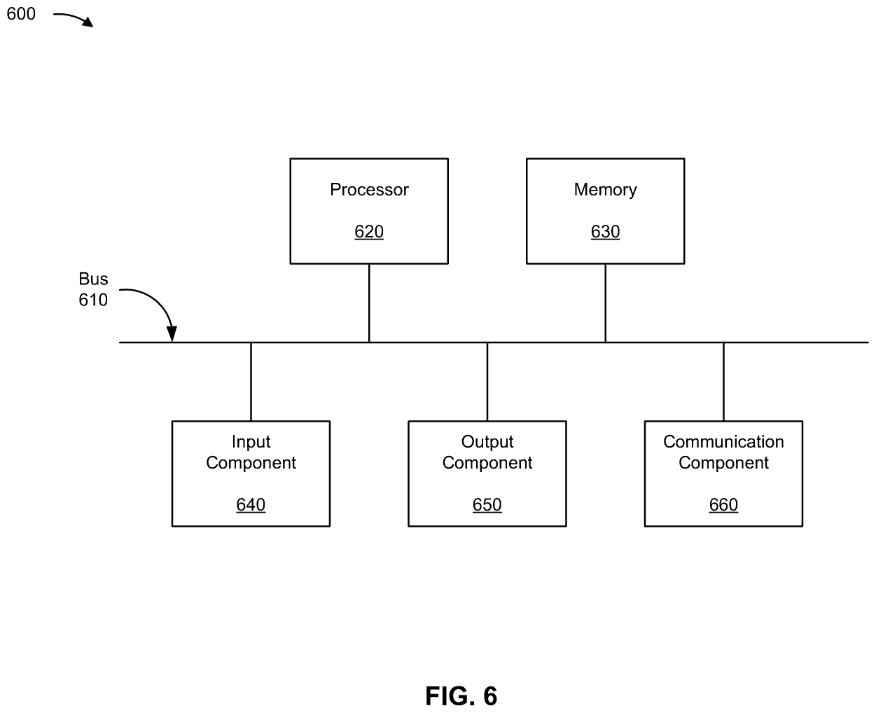

FIGS. 1A-1D are diagrams of an example implementation 100 associated with robotic resource allocation. As shown in FIGS. 1A-1D, example implementation 100 includes an ordering system, an item and warehouse database, a robot controller, one or more user devices, and one or more robotic devices. These devices are described in more detail below in connection with FIG. 5 and FIG. 6.

As shown in FIG. 1A and by reference number 105, the ordering system may transmit, and the robot controller may receive, a list of a set of items. The list of the set of items may be based on orders (e.g., one or more orders). For example, the ordering system may receive indications of the orders from a server that manages (or is at least associated with) a website listing items for sale. Alternatively, the ordering system may receive indications of the orders directly from user devices accessing the website. Alternatively, the ordering system may receive indications of the orders from user devices associated with waitstaff or other workers that take the orders from customers. Accordingly, the ordering system may compile the list of the set of items by identifying the set of items based on the indications of the orders.

In some implementations, the ordering system may transmit the list of the set of items periodically (e.g., according to a schedule, whether a default schedule or a schedule indicated by the robot controller). Alternatively, the ordering system may transmit the list on demand. For example, the robot controller may transmit a request to the ordering system, such that the ordering system transmits the list in response to the request.

Although shown as separate, the ordering system may be at least partially integrated (e.g., physically, logically, and/or virtually) with the robot controller in a single system. Accordingly, the list of the set of items may be transferred within the single system rather than between separate systems.

As shown by reference number 110, the item and warehouse database may transmit, and the robot controller may receive, a set of locations, a set of weights, and a set of volumes. The set of locations may be associated with the set of items and may be relative to a starting location (e.g., associated with a robotic device) or another reference location, such as an origin point. Accordingly, the set of items may be spread out such that the robotic device may be configured to move around to multiple locations, in the set of locations, to pickup some items and move those items a single destination.

In some implementations, the item and warehouse database may transmit a map indicating the set of items such that the robot controller determines a set of coordinate locations, associated with the set of items, based on the map. The map may include a data structure that identifies the items within a vector field that represents a physical space or a data structure that identifies the items within a bitmap that represents a physical space, among other examples. In some implementations, the robot controller may transmit a request (e.g., a database query) to the item and warehouse database, such that the item and warehouse database transmits the set of locations (and/or the map) in response to the request. The robot controller may transmit the request in response to receiving the list of the set of items from the ordering system.

The set of weights may be associated with the set of items, and the set of volumes may be similarly associated with the set of items. In some implementations, the robot controller may transmit a request (e.g., a database query) to the item and warehouse database, such that the item and warehouse database transmits the set of weights and the set of volumes in response to the request. The request may include indicators (e.g., product names, serial numbers, universal product codes (UPCs), and/or other types of identifiers) of the set of items. The robot controller may transmit the request in response to receiving the list of the set of items from the ordering system.

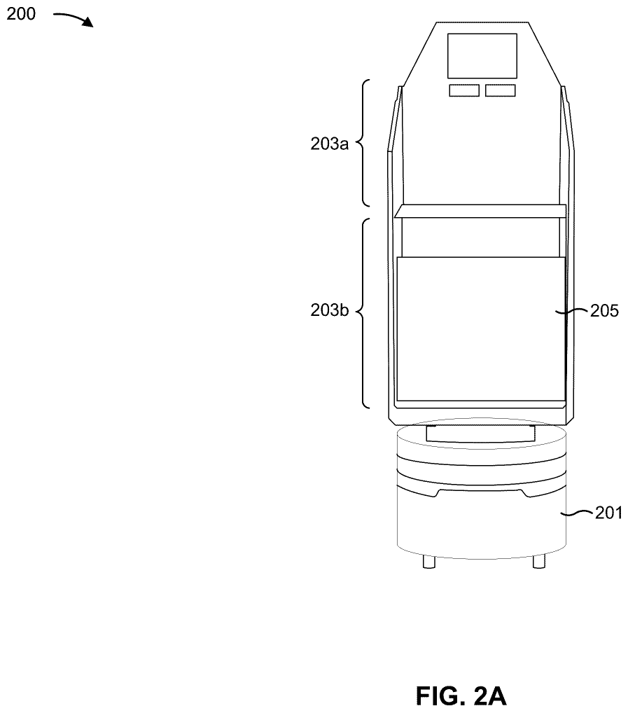

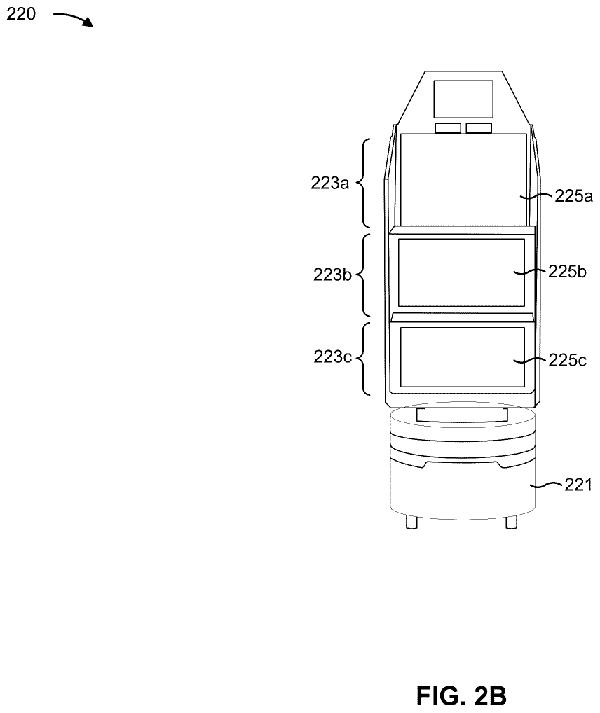

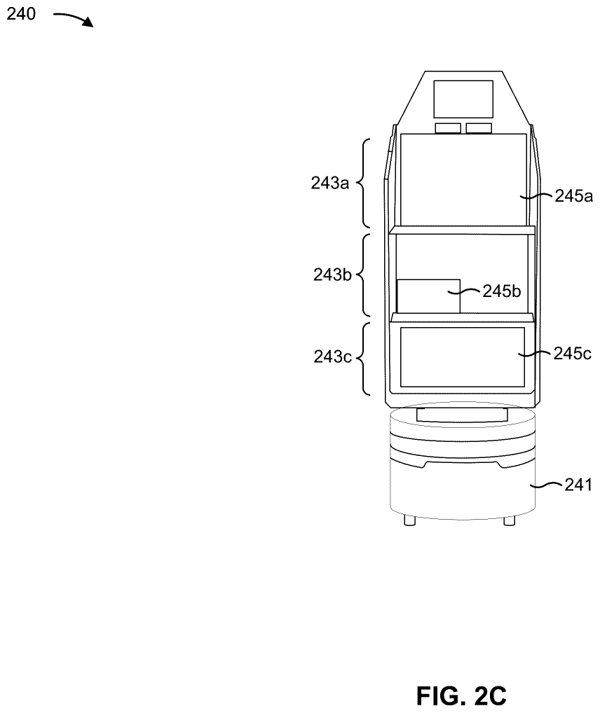

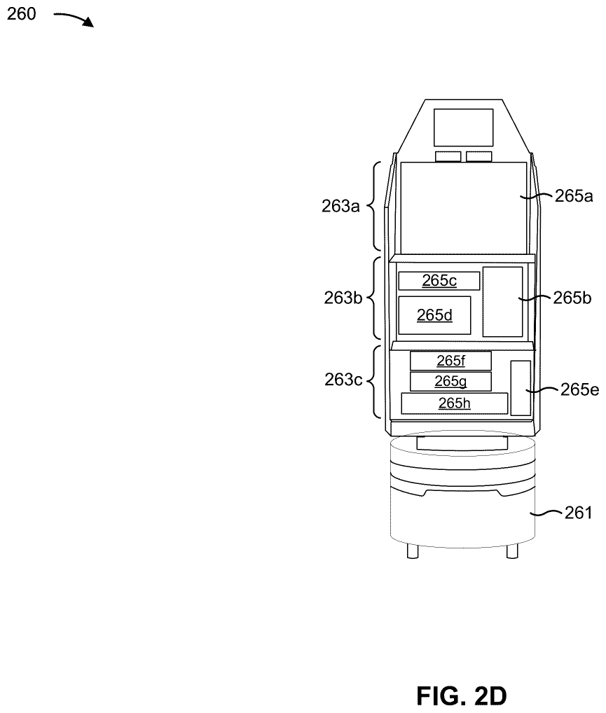

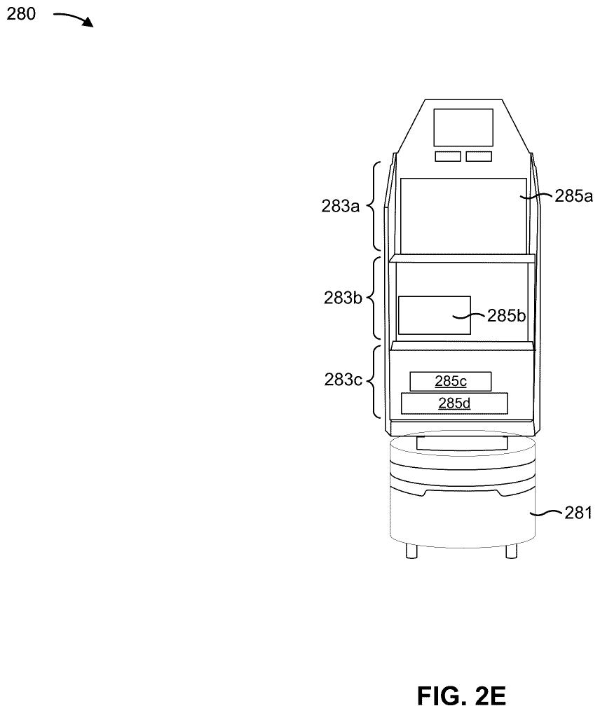

As shown in FIG. 1B and by reference number 115, the item and warehouse database may transmit, and the robot controller may receive, constraints associated with the robotic device(s). For example, the robot controller may receive at least a weight constraint and a size constraint. As described in connection with FIGS. 2A and 2C, the weight constraint may be associated with a maximum weight for a robotic device. As described in connection with FIGS. 2B and 2D, the size constraint may be associated with a maximum volume for a robotic device. In some implementations, the maximum volume may be a single maximum or may be a plurality of maxima (e.g., based on different shelving units associated with the robotic device). In some implementations, the robot controller may transmit a request (e.g., a database query) to the item and warehouse database, such that the item and warehouse database transmits the constraints in response to the request. The robot controller may transmit the request in response to receiving the list of the set of items from the ordering system.

In some implementations, the constraints may additionally include a delay budget (e.g., at least one delay budget) associated with an item (e.g., at least one item) in the list. For example, the delay budget may be associated with how long the item may be unrefrigerated, unfrozen, or left out to cool down, among other examples. As described in connection with FIG. 2E, the delay budget may override the weight constraint and/or the size constraint. For example, the robotic device may deliver the item within the delay budget even if the robotic device could physically accept additional items (e.g., more weight and/or more volume).

As shown by reference number 120, the robot controller may pack the set of items into groups. Each group may consist of a subset of the set of items and be intended for assignment to a robotic device. Accordingly, a group of items may be loaded and transferred to a destination by the robotic device in a single cycle.

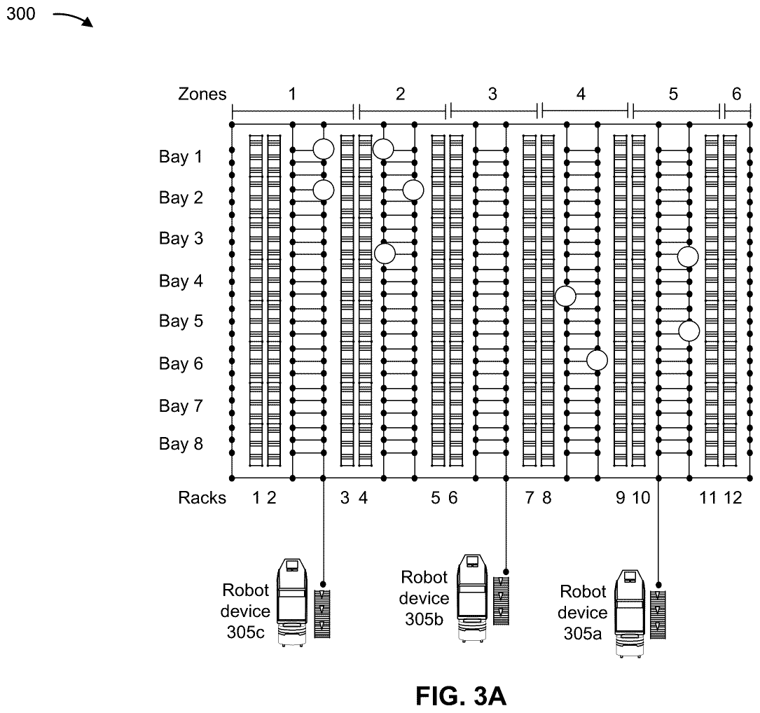

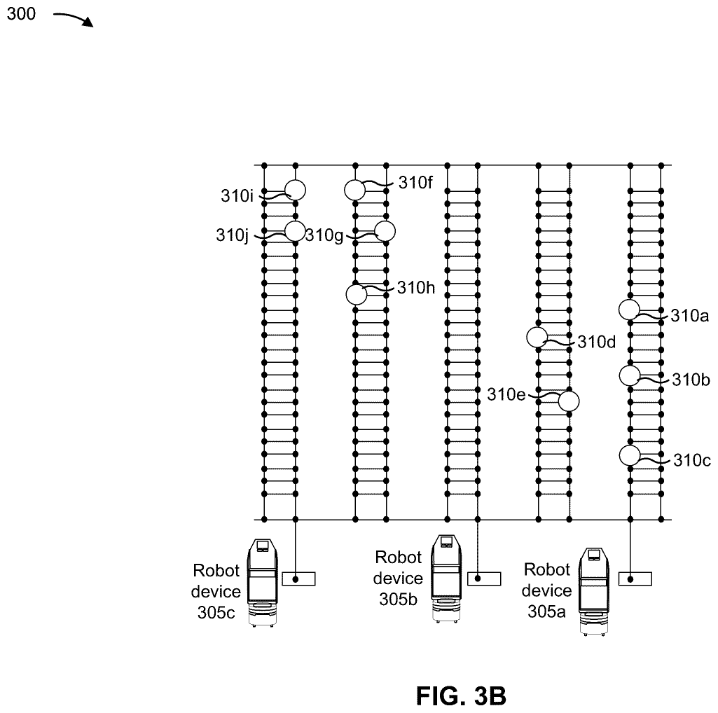

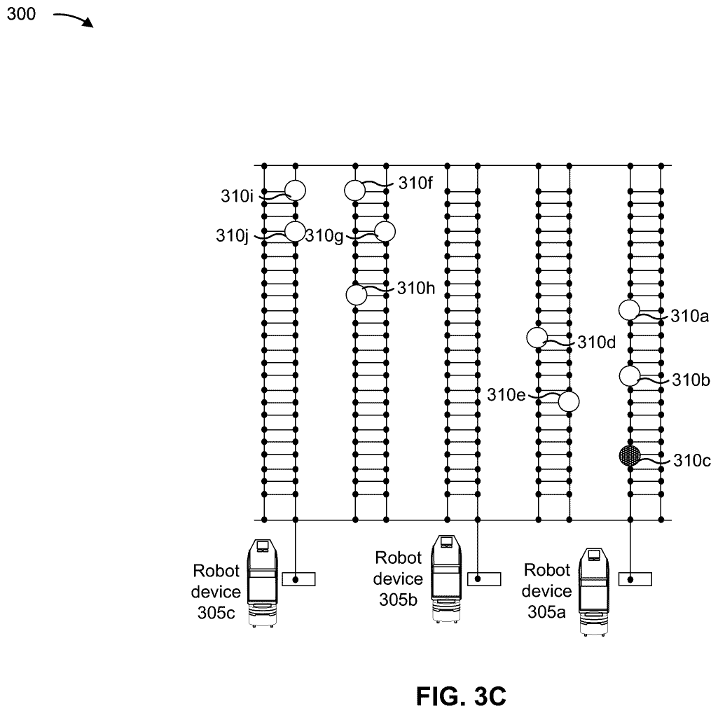

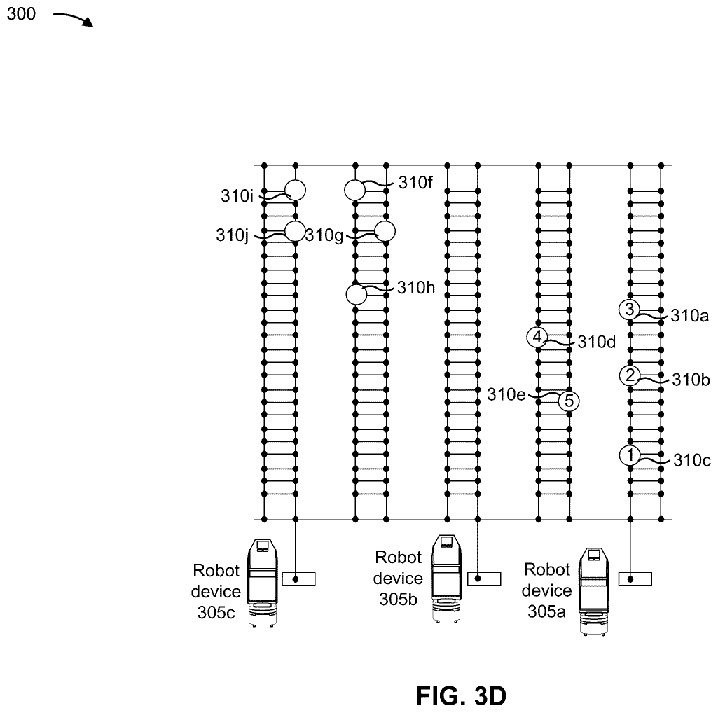

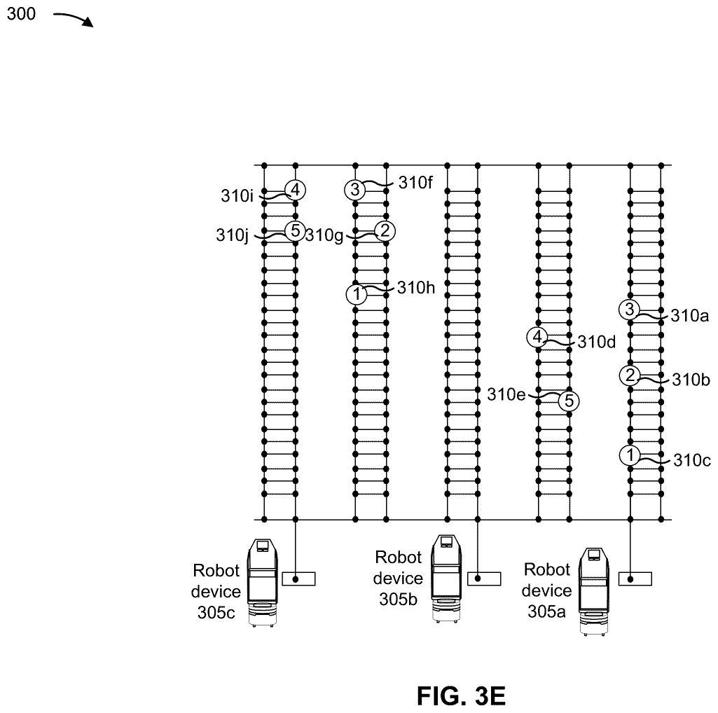

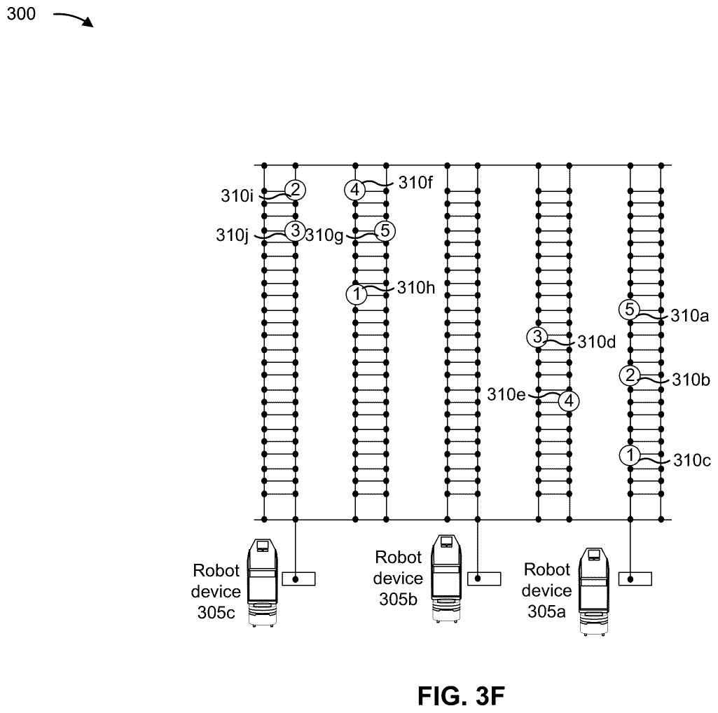

In some implementations, the robot controller may apply a bin-packing type algorithm to the set of items. For example, the robot controller may pack items into the group based on priorities associated with the items while minimizing a distance for the robotic device to travel, as described in connection with FIGS. 3A-3F. Additionally, the robot controller may pack the items subject to the weight constraint and the size constraint. In some implementations, the robot controller may additionally pack the items subject to an associated delay budget, as described above.

In order to minimize a total distance associated with the group of items based on the set of locations associated with the set of items, the robot controller may calculate the distance for a cycle of the robotic device according to the following example formula:

$$\{ d i s t ( s t a r {t}^{g} , {item}_{1}^{g} ) + dist ( {item}_{N}^{g} , {stop}^{g} ) + {\sum }_{i = 1}^{N - 1} dist ( {item}_{i}^{g} , {item}_{i + 1}^{g} ) \} ,$$

where dist(start^{g}, item₁^{g}) represents a distance between a starting location of the robotic device and a location associated with a first item in the group (g), dist (itemᵢ^{g}, itemᵢ₊₁^{g}) represents a distance between a location associated with previous item in the group and a location associated with a subsequent item in the group, dist (itemₙ^{g}, stop^{g}) represents a distance between a location associated with a final item in the group and the destination for the items, and N represents a quantity of items in the group. As used herein, “minimize” may refer to an estimation of a local minimum (e.g., using gradient descent or another type of iterative technique) or to an estimation of a global minimum (e.g., using a simplex algorithm or another type of algorithmic or heuristic technique).

Additionally, the robot controller may ensure that each packed item in a group satisfies the weight constraint according to the following example equation:

$${\sum }_{i = 1}^{N} weight ( {item}_{i}^{g} ) < Robot payload capacity ,$$

where weight(itemᵢ^{g}) represents the weight of the i^{th} item in the group, Robot payload capacity represents the weight constraint, and N represents a quantity of items in the group.

Similarly, the robot controller may ensure that each packed item in a group satisfies the size constraint according to the following example equation:

$${\sum }_{i = 1}^{n} νolume ( {item}_{i}^{g} ) < {\sum }_{j = 1}^{s} νolume ( {shelf}_{j} ) ,$$

where volume (itemᵢ^{g}) represents the size of the i^{th} item in the group, volume(shelfⱼ) represents the size constraint associated with the robotic device (or with a shelf of the robotic device), s represents a quantity of shelves associated with the robotic device, and n represents a quantity of items in the group.

For an item associated with a delay budget, the robot controller may ensure that the item, as packed in the group, satisfies the delay budget according to the following example equation:

$$\{ time ( {item}_{N}^{g} , {stop}^{g} ) + {\sum }_{i = 1}^{N} time ( {item}_{i}^{g} ) \} \leq {( Delay Budget )}^{g} ,$$

where time (itemᵢ^{g}) represents a time to move from a current location to an i^{th} item in the group, where the i^{th} item is subsequent to the item associated with the delay budget, time (itemₙ^{g}, stop^{g}) represents a time to move from a final item of the group to the destination, (Delay Budget)^{g} represents the delay budget, and N represents a quantity of items in the group.

Although this example is described in connection with the weight constraint, the size constraint, and/or the delay budget being applied after distance minimization, in other examples, the robot controller may additionally or alternatively calculate a processing cost for each item based on a distance, a size, a weight, and/or a delay budget (if applicable) associated with the item. Accordingly, the robot controller may pack the items based on the processing costs associated with the items in addition to, or as an alternative to, packing the items based on minimizing a total distance.

The robot controller may apply the constraints differently in other examples. For example, the robot controller may pack any items with a delay budget only as a final item (or as a penultimate item) in a group.

Additionally, in some implementations, and as shown in FIG. 1C and by reference number 125, the item and warehouse database may transmit, and the robot controller may receive, worker information. For example, the robot controller may receive an indication of a set of workers. The indication may encode a set of shifts associated with the set of workers. Accordingly, as shown by reference number 130, based on when the set of workers are available, the robot controller may assign the groups of items to selected workers of the set of workers. For example, the robot controller may assign higher priority groups to workers with earlier shifts as compared with lower priority groups. Priority of a group may be based on a mean priority, a median priority, or another combinatory measure of priorities associated with items included in the group.

As shown by reference number 135, the robot controller may transmit, and the user device(s) may receive, indications of the assigned groups of items. The user device(s) may be associated with the set of workers. The robot controller may transmit emails, text messages, push notifications, and/or other types of notifications to the user device(s).

In some implementations, in order to further improve efficiency, the set of workers may be associated with a set of zones. For example, each worker may be associated with a zone of a warehouse, a restaurant, or another physical location associated with the robotic device(s). Accordingly, the item and warehouse database may transmit, and the robot controller may receive, an indication of the set of the zones (e.g., in a data structure relating identifiers of the zones to identifiers of the workers). Accordingly, the robot controller may assign a group of items to a worker further based on the items in the group being located within the zone associated with the worker.

Alternatively, the robot controller may assign a group of items to a plurality of workers. For example, when the group of items includes items across multiple zones, the robot controller may assign the group to a single robotic device but multiple workers (e.g., associated with the multiple zones).

As shown in FIG. 1D and by reference number 140, the item and warehouse database may transmit, and the robot controller may receive, robot information. For example, the robot controller may receive an indication of charging capabilities associated with the robotic devices. Accordingly, the robot controller may determine when (and for how long) the robotic devices must be charged. As shown by reference number 145, based on when the robotic devices will have charge and are available, the robot controller may assign the groups of items to the robotic devices. For example, the robot controller may assign higher priority groups to robotic devices scheduled for later charging cycles as compared with lower priority groups. As described above, assignment of a group may be based on a mean priority, a median priority, or another combinatory measure of priorities associated with items included in the group.

As shown by reference number 150, the robot controller may transmit instructions to the robotic devices to retrieve items in the assigned groups. For example, the robot controller may feed high-level retrieval instructions (e.g., in object-oriented code and/or in human-readable data structures) to drivers associated with the robotic device for translation into low-level instructions (e.g., in machine code and/or in machine-readable data structures) that are sent to the robotic devices (e.g., wirelessly or via wires to docks associated with the robotic devices).

By using techniques as described in connection with FIGS. 1A-1D, the robot controller may pack the groups of items based on minimizing the total distance as well as satisfying the weight constraint, the size constraint, and/or any applicable delay budgets. As a result, the robotic device(s) are routed more efficiently in order to conserve power, processing resources, and memory resources.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

FIGS. 2A, 2B, 2C, 2D, and 2E are diagrams of example robotic devices 200, 220, 240, 260, and 280, respectively. Robotic devices are described in more detail below in connection with FIG. 5 and FIG. 6.

As shown in FIG. 2A, the example robotic device 200 includes a movement component 201 as well as a first shelf 203a and a second shelf 203b. As further shown in FIG. 2A, an item 205 may satisfy a weight constraint associated with the example robotic device 200. In some implementations, the example robotic device 200 may deliver the item 205 to a destination because no additional items could be added without violating the weight constraint, even when the example robotic device 200 could accept additional items without violating a size constraint associated with the first shelf 203a.

As shown in FIG. 2B, the example robotic device 220 includes a movement component 221 as well as a first shelf 223a, a second shelf 223b, and a third shelf 223c. As further shown in FIG. 2B, items 225a, 225b, and 225c may satisfy size constraints respectively associated with the first shelf 223a, the second shelf 223b, and the third shelf 223c. In some implementations, the example robotic device 220 may deliver the items 225a, 225b, and 225c to a destination because no additional items could be added without violating the size constraints, even when the example robotic device 200 could accept additional items without violating a weight constraint associated with the example robotic device 200.

As shown in FIG. 2C, the example robotic device 240 includes a movement component 241 as well as a first shelf 243a, a second shelf 243b, and a third shelf 243c. As further shown in FIG. 2C, items 245a, 245b, and 245c may satisfy a weight constraint associated with the example robotic device 240. In some implementations, the example robotic device 240 may deliver the items 245a, 245b, and 245c to a destination because no additional items could be added without violating the weight constraint, even when the example robotic device 240 could accept additional items without violating a size constraint associated with the second shelf 243b.

As shown in FIG. 2D, the example robotic device 260 includes a movement component 261 as well as a first shelf 263a, a second shelf 263b, and a third shelf 263c. As further shown in FIG. 2D, item 265a may satisfy a size constraint associated with the first shelf 263a, items 265b, 265c, and 265d may satisfy a size constraint associated with the second shelf 263b, and items 265e, 265f, 265g, and 265h may satisfy a size constraint associated with the third shelf 263c. In some implementations, the example robotic device 260 may deliver the items to a destination because no additional items could be added without violating the size constraints, even when the example robotic device 260 could accept additional items without violating a weight constraint associated with the example robotic device 260.

As shown in FIG. 2E, the example robotic device 280 includes a movement component 281 as well as a first shelf 283a, a second shelf 283b, and a third shelf 283c. Item 285a may be associated with a delay budget. Accordingly, the example robotic device 280 may deliver the items 285a, 285b, 285c, and 285d to a destination because no additional items could be added without violating the delay budget, even when the example robotic device 280 could accept additional items without violating a weight constraint associated with the example robotic device 280, a size constraint associated with the second shelf 283b, or a size constraint associated with the third shelf 283c.

As indicated above, FIGS. 2A-2E are provided as examples. Other examples may differ from what is described with regard to FIGS. 2A-2E. For example, a robotic device may have weight constraints associated with individual shelves rather than a single weight constraint as a whole.

FIGS. 3A-3F are diagrams of an example implementation 300 associated with packing groups of items. As shown in FIGS. 3A-3F, example implementation 300 includes robotic devices 305a, 305b, and 305c. These devices are described in more detail below in connection with FIG. 5 and FIG. 6.

As shown in FIG. 3A, the example implementation 300 includes items located across different zones (e.g., of a warehouse or a restaurant, among other examples) that have multiple bays and multiple racks. In order to pack a group of items for assignment to each robotic device, a robot controller may sort items based on weight constraints and size constraints for the robotic devices. In FIG. 3B, items 310a, 310b, 310c, 310d, and 310e are grouped to satisfy the constraints for the robotic device 305a, and items 310f, 310g, 310h, 310i, and 310j are grouped to satisfy the constraints for the robotic device 305c. As shown in FIG. 3C, the item 310c is selected to pack first because the item 310c is closest to the robotic device 305a. Subsequently, as shown in FIG. 3D, items 310b, 310a, 310d, and 310e are ordered based on distance to the robotic device 305a while still satisfying the weight constraint and the size constraint associated with the robotic device 305a. Similarly, as shown in FIG. 3E, items 310h, 310g, 310f, 310i, and 310j are ordered for the robotic device 305c.

Other examples may additionally include a delay budget, associated with at least one item, to satisfy. For example, as shown in FIG. 3F, items 310c, 310b, 310a, 310d, and 310e are ordered based on distance to the robotic device 305a while accounting for a delay budget associated with the item 310a (e.g., by ordering the item 310a last). Similarly, as further shown in FIG. 3F, items 310h, 310i, 310j, 310f, and 310g are ordered based on distance to the robotic device 305b while accounting for a delay budget associated with the item 310f (e.g., by ordering the item 310f second-to-last). Additionally, or alternatively, although the example implementation 300 is described using minimization of distance subject to weight and size constraints, other implementations may calculate processing costs for the items and pack the items according to minimization of processing cost.

Although the example implementation 300 is described in connection with calculating distances based on locations of the robotic devices 305a, 305b, and 305c, other examples may include calculating distances based on destinations, even when the robotic devices 305a, 305b, and 305c are currently located elsewhere.

As indicated above, FIGS. 3A-3F are provided as an example. Other examples may differ from what is described with regard to FIGS. 3A-3F.

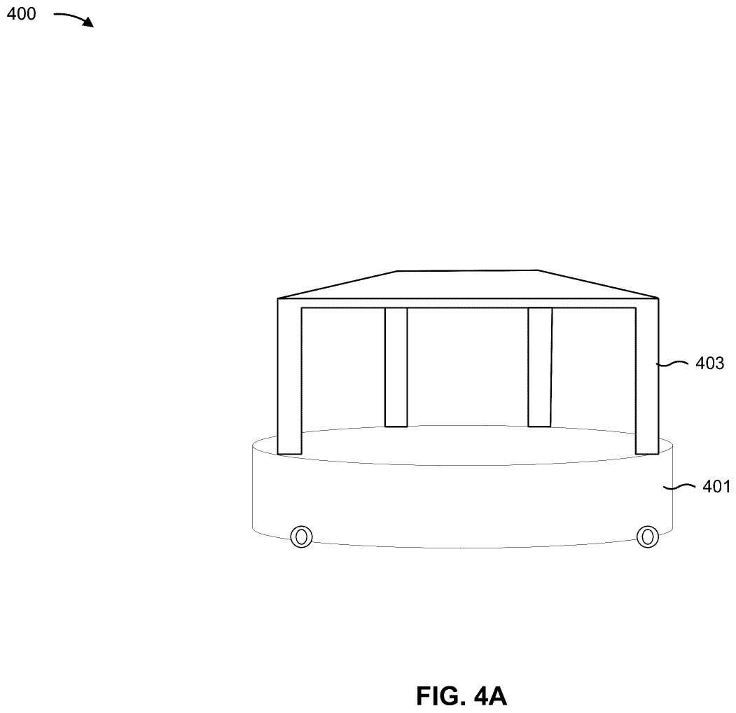

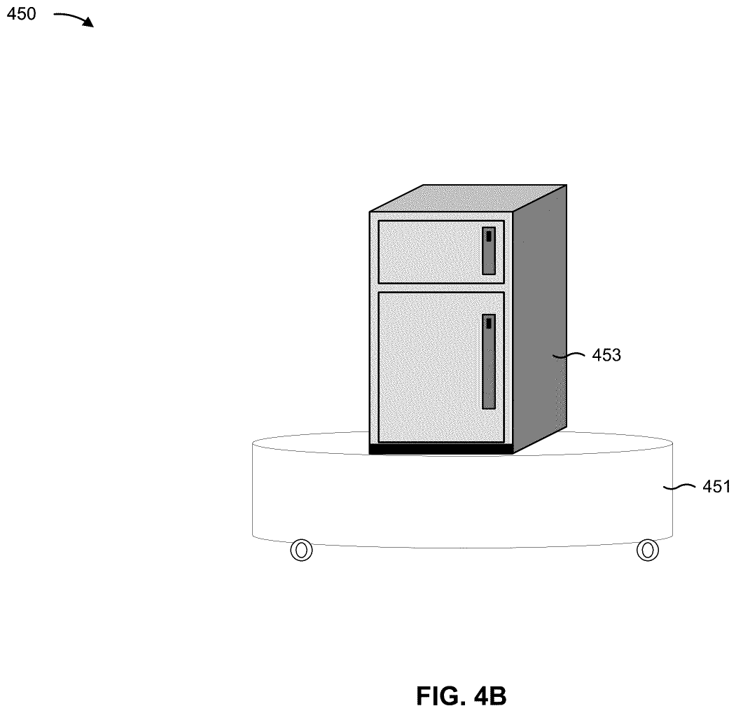

FIGS. 4A and 4B are diagrams of example robotic devices 400 and 450, respectively. Robotic devices are described in more detail below in connection with FIG. 5 and FIG. 6.

As shown in FIG. 4A, the example robotic device 400 may be a freight robot that includes a movement component 401 that supports a flat surface. As further shown in FIG. 4A, an item 403 may satisfy a size constraint associated with the example robotic device 400. For example, the item 403 may be sufficiently wide (and/or long) such that additional items ought not be added to the example robotic device 400. In some implementations, the example robotic device 400 may deliver the item 403 to a destination because no additional items could be added without violating the size constraint, even when the example robotic device 400 could accept additional items without violating a weight constraint associated with the example robotic device 400.

As shown in FIG. 4B, the example robotic device 450 may be a freight robot that includes a movement component 451 that supports a flat surface. As further shown in FIG. 4B, an item 453 may satisfy a weight constraint associated with the example robotic device 450. In some implementations, the example robotic device 450 may deliver the item 453 to a destination because no additional items could be added without violating the weight constraint, even when the example robotic device 450 could accept additional items without violating a size constraint associated with the example robotic device 450.

As indicated above, FIGS. 4A-4B are provided as examples. Other examples may differ from what is described with regard to FIGS. 4A-4B. For example, a robotic device may have a size constraint associated with height in addition to a size constraint associated with width and/or length.

FIG. 5 is a diagram of an example environment 500 in which systems and/or methods described herein may be implemented. As shown in FIG. 5, environment 500 may include an ordering system 510, a device implementing an item and warehouse database 520, a robot controller 530, one or more user devices 540, one or more robotic devices 550, and a network 560. Devices of environment 500 may interconnect via wired connections, wireless connections, or a combination of wired and wireless connections.

The ordering system 510 may include one or more devices capable of receiving, generating, storing, processing, providing, and/or routing information associated with orders, as described elsewhere herein. The ordering system 510 may include a communication device and/or a computing device. For example, the ordering system 510 may include a server, such as an application server, a client server, a web server, a database server, a host server, a proxy server, a virtual server (e.g., executing on computing hardware), or a server in a cloud computing system. In some implementations, the ordering system 510 may include computing hardware used in a cloud computing environment. The ordering system 510 may communicate with one or more other devices of environment 500, as described elsewhere herein.

The item and warehouse database 520 may be implemented using one or more devices capable of receiving, generating, storing, processing, and/or providing information associated with items, a warehouse, and/or robotic devices, as described elsewhere herein. The item and warehouse database 520 may be implemented using a communication device and/or a computing device. For example, the item and warehouse database 520 may be implemented using a server, a database server, an application server, a client server, a web server, a host server, a proxy server, a virtual server (e.g., executing on computing hardware), a server in a cloud computing system, a device that includes computing hardware used in a cloud computing environment, or a similar type of device. The item and warehouse database 520 may communicate with one or more other devices of environment 500, as described elsewhere herein.

The robot controller 530 may include one or more devices capable of receiving, generating, storing, processing, providing, and/or routing information associated with items assigned to the robotic device(s) 550, as described elsewhere herein. The robot controller 530 may include a communication device and/or a computing device. For example, the robot controller 530 may include a server, such as an application server, a client server, a web server, a database server, a host server, a proxy server, a virtual server (e.g., executing on computing hardware), or a server in a cloud computing system. In some implementations, the robot controller 530 may include computing hardware used in a cloud computing environment. Additionally, or alternatively, the robot controller 530 may include a router, such as a label switching router (LSR), a label edge router (LER), an ingress router, an egress router, a provider router (e.g., a provider edge router or a provider core router), a virtual router, or another type of router. Additionally, or alternatively, the robot controller 530 may include a gateway, a switch, a firewall, a hub, a bridge, a reverse proxy, a server (e.g., a proxy server, a cloud server, or a data center server), a load balancer, and/or a similar device. In some implementations, the robot controller 530 may be a physical device implemented within a housing, such as a chassis. In some implementations, the robot controller 530 may be a virtual device implemented by one or more computing devices of a cloud computing environment or a data center. In some implementations, a group of robot controllers 530 may be a group of data center nodes that are used to route the robotic device(s) 550 through a warehouse, a restaurant, or another type of physical area.

The user device(s) 540 may include one or more devices capable of receiving, generating, storing, processing, and/or providing information associated with items assigned to workers, as described elsewhere herein. The user device(s) 540 may include a communication device and/or a computing device. For example, the user device(s) 540 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device(s) 540 may communicate with one or more other devices of environment 500, as described elsewhere herein.

The robotic device(s) 550 may include one or more devices capable of physically carrying items while moving through a warehouse, a restaurant, or another type of physical area, as described elsewhere herein. The robotic device(s) 550 may include a communication device and/or a computing device. The robotic device(s) 550 may further include a movement component (e.g., wheels, legs, or another type of hardware that propels the robotic device(s) forward, backward, and/or sideways) and a physical storage component (e.g., one or more shelves or another type of hardware that stows items). The robotic device(s) 550 may communicate with one or more other devices of environment 500, as described elsewhere herein. In some implementations, the robotic devices 550 may include heterogeneous robots. For example, the robotic devices 550 may include a heterogeneous robot team that exercises cooperative behavior.

The network 560 may include one or more wired and/or wireless networks. For example, the network 560 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 560 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600 associated with robotic resource allocation. The device 600 may correspond to an ordering system 510, a device implementing item and warehouse database 520, a robot controller 530, a user device 540, and/or a robotic device 550. In some implementations, the ordering system 510, the device implementing item and warehouse database 520, the robot controller 530, the user device 540, and/or the robotic device 550 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

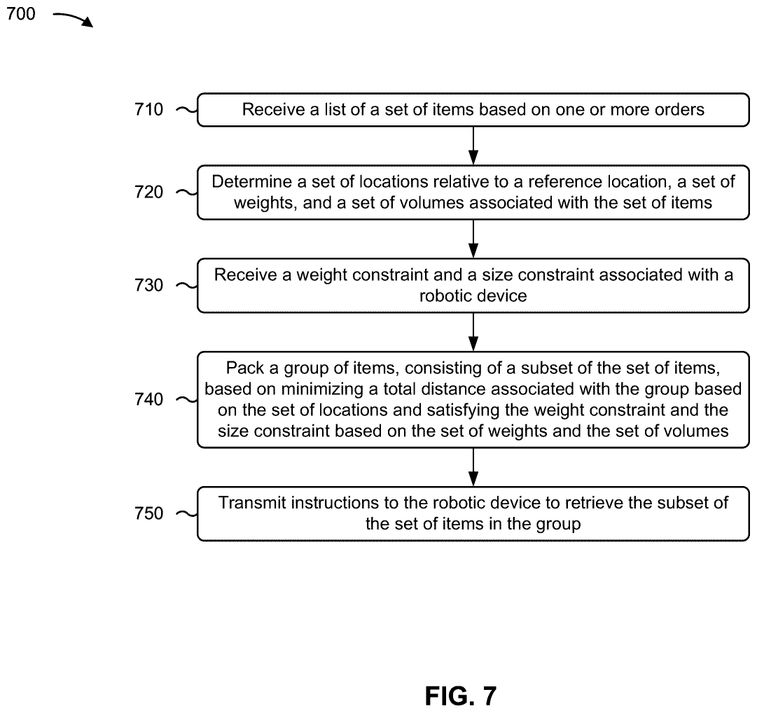

FIG. 7 is a flowchart of an example process 700 associated with robotic resource allocation. In some implementations, one or more process blocks of FIG. 7 are performed by a robot controller (e.g., robot controller 530). In some implementations, one or more process blocks of FIG. 7 are performed by another device or a group of devices separate from or including the robot controller, such as an ordering system (e.g., ordering system 510), an item and warehouse database (e.g., item and warehouse database 520), a user device (e.g., user device 540), and/or a robotic device (e.g., robotic device 550). Additionally, or alternatively, one or more process blocks of FIG. 7 may be performed by one or more components of device 600, such as processor 620, memory 630, input component 640, output component 650, and/or communication component 660.

As shown in FIG. 7, process 700 may include receiving a list of a set of items based on one or more orders (block 710). For example, the robot controller may receive a list of a set of items based on one or more orders, as described herein.

As further shown in FIG. 7, process 700 may include determining a set of locations relative to a reference location, a set of weights, and a set of volumes associated with the set of items (block 720). For example, the robot controller may determine a set of locations relative to a reference location, a set of weights, and a set of volumes associated with the set of items, as described herein.

As further shown in FIG. 7, process 700 may include receiving a weight constraint and a size constraint associated with a robotic device (block 730). For example, the robot controller may receive a weight constraint and a size constraint associated with a robotic device, as described herein.

As further shown in FIG. 7, process 700 may include packing a group of items, consisting of a subset of the set of items, based on minimizing a total distance associated with the group based on the set of locations and satisfying the weight constraint and the size constraint based on the set of weights and the set of volumes (block 740). For example, the robot controller may pack a group of items, consisting of a subset of the set of items, based on minimizing a total distance associated with the group based on the set of locations and satisfying the weight constraint and the size constraint based on the set of weights and the set of volumes, as described herein.

As further shown in FIG. 7, process 700 may include transmitting instructions to the robotic device to retrieve the subset of the set of items in the group (block 750). For example, the robot controller may transmit instructions to the robotic device to retrieve the subset of the set of items in the group, as described herein.

Process 700 may include additional implementations, such as any single implementation or any combination of implementations described below and/or in connection with one or more other processes described elsewhere herein.

In a first implementation, determining the set of locations includes determining a set of coordinate locations based on a map indicating the set of items.

In a second implementation, alone or in combination with the first implementation, determining the set of weights and the set of volumes includes receiving the set of weights and the set of volumes from a database associated with the set of items.

In a third implementation, alone or in combination with one or more of the first and second implementations, process 700 includes receiving an additional weight constraint and an additional size constraint associated with an additional robotic device; packing an additional group of items, consisting of an additional subset of the set of items, based on minimizing a total distance associated with the additional group based on the set of locations and satisfying the additional weight constraint and the additional size constraint based on the set of weights and the set of volumes; and transmitting instructions to the additional robotic device to retrieve the additional subset of the set of items in the additional group.

In a fourth implementation, alone or in combination with one or more of the first through third implementations, packing the group of items includes applying a bin-packing type algorithm to the set of items.

In a fifth implementation, alone or in combination with one or more of the first through fourth implementations, process 700 includes receiving at least one delay budget associated with at least one item in the group, such that packing the group of items is further based on satisfying the at least one delay budget.

In a sixth implementation, alone or in combination with one or more of the first through fifth implementations, process 700 includes receiving an indication of a set of workers, assigning the group of items to a selected worker, of the set of workers, based on a shift associated with the selected worker, and transmitting an indication of the group of items to a user device associated with the selected worker.

In a seventh implementation, alone or in combination with one or more of the first through sixth implementations, process 700 includes receiving an indication of a set of zones associated with the set of workers, such that the group of items is assigned to the selected worker further based on a zone, of the set of zones, associated with the selected worker.

In an eighth implementation, alone or in combination with one or more of the first through seventh implementations, process 700 includes receiving an indication of a set of robotic devices, including the robotic device, and a set of charging capabilities associated with the set of robotic devices, and assigning the group of items to the robotic device based on a charging capability, of the set of charging capabilities, associated with the robotic device.

In a ninth implementation, alone or in combination with one or more of the first through eighth implementations, process 700 includes receiving an indication of a set of workers, assigning the group of items to a plurality of workers, of the set of workers, based on zones associated with the plurality of workers, and transmitting indications of the group of items to user devices associated with the plurality of workers.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving a list of a set of items based on one or more orders;
determining a set of locations relative to a reference location, a set of weights, and a set of volumes associated with the set of items;
receiving a weight constraint and a size constraint associated with a robotic device;
packing a group of items, consisting of a subset of the set of items, based on minimizing a total distance associated with the group based on the set of locations and satisfying the weight constraint and the size constraint based on the set of weights and the set of volumes; and
transmitting instructions to the robotic device to retrieve the subset of the set of items in the group.

2. The method of claim 1, wherein determining the set of locations comprises:
determining a set of coordinate locations based on a map indicating the set of items.

3. The method of claim 1, wherein determining the set of weights and the set of volumes comprises:
receiving the set of weights and the set of volumes from a database associated with the set of items.

4. The method of claim 1, further comprising:
receiving an additional weight constraint and an additional size constraint associated with an additional robotic device;
packing an additional group of items, consisting of an additional subset of the set of items, based on minimizing a total distance associated with the additional group based on the set of locations and satisfying the additional weight constraint and the additional size constraint based on the set of weights and the set of volumes; and
transmitting instructions to the additional robotic device to retrieve the additional subset of the set of items in the additional group.

5. The method of claim 1, wherein packing the group of items comprises:
applying a bin-packing type algorithm to the set of items.

6. The method of claim 1, further comprising:
receiving at least one delay budget associated with at least one item in the group,
wherein packing the group of items is further based on satisfying the at least one delay budget.

7. The method of claim 1, further comprising:
receiving an indication of a set of workers;
assigning the group of items to a selected worker, of the set of workers, based on a shift associated with the selected worker; and
transmitting an indication of the group of items to a user device associated with the selected worker.

8. The method of claim 7, further comprising:
receiving an indication of a set of zones associated with the set of workers,
wherein the group of items is assigned to the selected worker further based on a zone, of the set of zones, associated with the selected worker.

9. The method of claim 1, further comprising:
receiving an indication of a set of robotic devices, including the robotic device, and a set of charging capabilities associated with the set of robotic devices; and
assigning the group of items to the robotic device based on a charging capability, of the set of charging capabilities, associated with the robotic device.

10. The method of claim 1, further comprising:
receiving an indication of a set of workers;
assigning the group of items to a plurality of workers, of the set of workers, based on zones associated with the plurality of workers; and
transmitting indications of the group of items to user devices associated with the plurality of workers.

11. A device, comprising:
one or more memories; and
one or more processors, communicatively coupled to the one or more memories, configured to:
receive a set of items based on one or more orders;
determine a set of locations relative to a reference location, a set of weights, and a set of volumes associated with the set of items;
receive a weight constraint and a size constraint associated with a robotic device;
pack a group of items, consisting of a subset of the set of items, based on minimizing a total distance associated with the group based on the set of locations and satisfying the weight constraint and the size constraint based on the set of weights and the set of volumes; and
transmit instructions to the robotic device to retrieve the subset of the set of items in the group.

12. The device of claim 11, wherein the one or more processors are further configured to:
receive an additional weight constraint and an additional size constraint associated with an additional robotic device;
pack an additional group of items, consisting of an additional subset of the set of items, based on minimizing a total distance associated with the additional group based on the set of locations and satisfying the additional weight constraint and the additional size constraint based on the set of weights and the set of volumes; and
transmit instructions to the additional robotic device to retrieve the additional subset of the set of items in the additional group.

13. The device of claim 11, wherein the one or more processors are further configured to:
receive at least one delay budget associated with at least one item in the group,
wherein the one or more processors are configured to pack the group of items is further based on satisfying the at least one delay budget.

14. The device of claim 11, wherein the one or more processors are further configured to:
receive an indication of a set of workers;
assign the group of items to a selected worker, of the set of workers, based on a shift associated with the selected worker; and
transmit an indication of the group of items to a user device associated with the selected worker.

15. The device of claim 14, wherein the one or more processors are further configured to:
receive an indication of a set of zones associated with the set of workers,
wherein the group of items is assigned to the selected worker further based on a zone, of the set of zones, associated with the selected worker.

16. The device of claim 11, wherein the one or more processors are further configured to:
receive an indication of a set of robotic devices, including the robotic device, and a set of charging capabilities associated with the set of robotic devices; and
assign the group of items to the robotic device based on a charging capability, of the set of charging capabilities, associated with the robotic device.

17. A non-transitory computer-readable medium storing a set of instructions, the set of instructions comprising:
one or more instructions that, when executed by one or more processors of a device, cause the device to:
receive a set of items based on one or more orders;
determine a set of locations relative to a reference location, a set of weights, and a set of volumes associated with the set of items;
receive a weight constraint and a size constraint associated with a robotic device;
pack a group of items, consisting of a subset of the set of items, based on minimizing a total distance associated with the group based on the set of locations and satisfying the weight constraint and the size constraint based on the set of weights and the set of volumes; and
transmit instructions to the robotic device to retrieve the subset of the set of items in the group.

18. The non-transitory computer-readable medium of claim 17, wherein the one or more instructions, when executed by the one or more processors, further cause the device to:
receive at least one delay budget associated with at least one item in the group,
wherein packing the group of items is further based on satisfying the at least one delay budget.

19. The non-transitory computer-readable medium of claim 17, wherein the one or more instructions, when executed by the one or more processors, further cause the device to:
receive an indication of a set of workers;
assign the group of items to a selected worker, of the set of workers, based on a shift associated with the selected worker; and
transmit an indication of the group of items to a user device associated with the selected worker.

20. The non-transitory computer-readable medium of claim 17, wherein the one or more instructions, when executed by the one or more processors, further cause the device to:
receive an indication of a set of robotic devices, including the robotic device, and a set of charging capabilities associated with the set of robotic devices; and
assign the group of items to the robotic device based on a charging capability, of the set of charging capabilities, associated with the robotic device.
